(19) United States
(12) Patent Application Publication
(10) Pub. No.: US 2003/0195851 A1
(43) Pub. Date: Oct. 16, 2003

(54) System for managing distribution of digital audio content

(76) Inventor: Lance D. Ong, Hackensack, NJ (US)

Correspondence Address: LEIGHTON K. CHONG, OSTRAGER CHONG & FLAHERTY (HAWAII), 841 BISHOP STREET, SUITE 1200, HONOLULU, HI, 96813, US

(21) Appl. No.: 10/411,986

(22) Filed: Apr. 11, 2003

Related U.S. Application Data
(60) Provisional application No. 60/372,249, filed on Apr. 11, 2002.

(51) Int. Cl. G06F 17/60

(52) U.S. Cl. 705/50

(57) ABSTRACT

A system and method for managing distribution of digital audio content employs vector encoding of audio content representing segments of the audio waveform. High frequency vectors are discriminated by their amplitude increment per short traversal times exceeding a predetermined level, and are flagged in the audio data file. A distributor or host ID code is embedded in the audio data file designating the authorized source or host environment for playback of the audio data file. A vector-decoding-enabled player associated with the authorized host is allowed to playback the audio data file with full quality and an unlimited number of times. If the audio data file is copied or downloaded to a new host environment, then the player associated with the new host will detect that the host ID code embedded in the audio data file does not match the new host, and will playback only the low frequency vectors of the audio data file and only for a limited number of times. The recipient of the audio data file is required to log-on to an online registration site and pay a license fee in order to obtain a host-ID code for the audio data file matching the current host environment in order to have full usage rights. The system allows multiple users to sample or share copies of the vector-encoded audio data files on peer-to-peer networks without infringing the rights of copyright holders. An improvement for flattening out noisy input signals is also provided in the method of vector encoding of the audio waveforms.

This U.S. patent application claims the priority of U.S. Provisional Application 60/372,249, filed on Apr. 11, 2002, entitled “Recording Industry Content Management Solution”, by the same inventor.

### FIELD OF THE INVENTION

This invention relates to a system for managing distribution of digital audio content and, particularly, to a system which enables highly effective compression of digital audio files as well as digital rights and content management functions in the handling of such files.

### BACKGROUND OF THE INVENTION

Digital audio content has improved significantly since the 1980s when 16-bit encoding and 44.1 Khz sampling was adopted as a new standard. Digital audio encoded in 16-bit bytes could represent a better dynamic range than previous recordings on vinyl records, and the 44.1 Khz sampling rate complied with the Nyquist rule that it should be twice the highest frequency the human ear can discern. However, current digital audio standards have increased the dynamic range for digital encoding to 24 bits and the sampling rate to 96 Khz for DVD audio content and as high as 192 Khz for “professional” applications. The amount of recorded data has grown from 45 MB for 4 minutes of stereo at 16-bits, 44.1 Khz recording, to 270 MB for that same 4 minutes at 24-bits, 192 Khz. The volume of data for digital audio files has thus increased more than 3× to 6× to obtain a higher resolution and quality of recorded sound.

At the same time, music lovers have found new channels on the Internet for accessing music. Hearing new music is of most interest when it can be sampled before purchase, and freely shared among friends with the same musical interests. The Internet has allowed users to readily share songs and even whole CDs with others by posting them on peer-to-peer networks. Concurrently, new compression methodologies have been developed to allow large digital audio files to be compressed into smaller files sizes for delivery across the Internet to a broad audience of users who have more limited bandwidth access. For example, MP3 encoding was developed as an offshoot of MPEG standards developed by the Motion Pictures Experts Group. The MP3 format has been widely used to share music files on peer-to-peer networks across the Internet. However, the ease with which music files can now be shared and transmitted ubiquitously on the Internet has led to widespread copyright piracy of illegally copied music, causing the recording industry billions of dollars in lost revenues. Widespread copyright piracy has also undermined economic incentives for recording artists to create new music and make it available in public distribution systems where it can be illegally copied.

### SUMMARY OF THE INVENTION

Accordingly, it is a principal object of the present invention to provide a system and method for controlling the distribution of digital audio content on the Internet so that users can readily share music to try out with others, while at the same time discouraging illegal copying. It is a further object to provide such a digital audio content distribution method which enables highly effective compression of digital audio files as well as digital rights and content management functions in the handling of such files.

In accordance with the present invention, a system and method for managing distribution of audio content comprises:

(a) digitally encoding the audio content into an audio data file containing a series of time-demarcated vectors representing segments of an audio waveform;

(b) determining the vectors representing high frequency segments exceeding a predetermined high frequency level, and marking the corresponding vectors with a tracer so that they can be traced upon playback;

(c) embedding a host-ID code in the audio data file designating an authorized host environment for full unlimited playback of the audio content from the audio data file;

(d) distributing the audio data file to a host environment having a unique host-ID code;

(e) upon determining a match of the host-ID code embedded in the audio data file with the host-ID code for the playback host environment, then enabling full unlimited playback of audio content from the audio data file by digitally decoding the audio waveform from the audio data file including the high frequency vectors; and

(f) upon determining no match of the host-ID code embedded in the audio data file with the host-ID code for the playback host environment, then enabling only low resolution, limited playback of audio content from the audio data file by digitally decoding the low frequency vectors of the audio data file and ignoring the high frequency vectors.

In a preferred embodiment of the invention, the digital encoding of audio content is obtained by “vector” encoding of the audio waveform into digital message packets representing waveform segments defined by polarity (up/down), number of amplitude increments, and elapsed time traversed by the amplitude increments. An example of such “vector” encoding of audio waveforms is described in U.S. Pat. No. 6,020,840 and 6,177,898, commonly owned by the same inventor, which are incorporated herein by reference. The high frequency segments can be determined as those having a relatively large amplitude increment in a short elapsed time exceeding a defined “high frequency level”. The high frequency digital messages are traced by setting a tracer bit in the “1” or “high” position or other message segment as appropriate. For trial or low resolution playback, the high frequency segments having tracers set are ignored and substituted with straight line interpolation to the low frequency waveform segments. This produces a low resolution output suitable only for sampling a music piece, but not for full use and enjoyment of the piece.

The original audio content may be purchased on a CD as a vector-encoded digital audio content file, and played back on any vector-decoding CD player. Commercial CD players can be modified to playback vector-encoded digital audio content file by installing firmware to handle the decoding. If the vector-encoded digital audio content file is copied or downloaded into another host environment, it can be played back if the host environment has a vector-decoding player installed. Upon attempted playback, the vector-decoding player can replace the original CD code embedded in the audio file with the owner's host-ID code, or the replacement can be performed by a secure online registration procedure. The host-ID code is a unique number identifying the host environment, for example, as may be generated from the user's machine serial number or the serial numbers of components in the host machine such as the microprocessor, hard drive, or operating system license number.

If the audio data file is subsequently copied or downloaded to another host environment (another user's PC or a portable digital file player), the vector-decoding player on the new host will check to see whether its host-ID code matches the host-ID code embedded in the audio file. If the host-ID code does not match, the player will enable only low resolution playback of audio content from the audio file by decoding only the digital messages unmarked as high frequency level and only for a limited number of times. This limited condition requires the user to log-on with an online registration service for payment of a license fee, in order to re-set the host-ID code for the new host environment in the audio file. Once the new host-ID code is set to match the new host environment, the user can playback the audio file with its full resolution for an unlimited number of times.

The invention thus allows multiple users on a public network, such as the Internet, the ability to share copyrighted digital audio files on a peer-to-peer network without infringing the rights of copyright holders. Further, it allows for licensing fee payments to be made online for works copied or otherwise distributed to others, while also controlling the further distribution of such copies, thereby allowing copyright holders to benefit monetarily from the distribution of their works within the public network. The embedding of the recognized host-ID code of the host environment in the audio file identifies the user or user's machine that is authorized for full playback of the audio file. If a copy of the audio file is passed to another host environment, the audio file will have limited functionality during attempted playback due to the trace marking of higher frequency sounds, and can only be played a limited number of times before the licensing procedure is required. When the new host environment has obtained authorization through an online licensing transaction, the host-ID code of the new host environment is embedded in the audio file, thereby enabling unlimited playback at full resolution. This system is adapted to handle hard copies of audio files, such as on CD or DVD reproductions, or file transfers via public or private networks. Desired rules of distribution can also be embedded in the audio file, such as defining the number of trial samplings before requiring licensing. The use of an online registration site enables the convenient collection of license payment to authorize usage of distributed copies.

Another aspect of the invention is an improvement to the vector encoding process to improve encoding where a noisy input signal is encountered and the transient response of the system. In the vector encoding process, each newly created data word is detected by a data ready signal and processed by a microprocessor as a vector defined by an incremental value (threshold value) and elapsed time for the input signal to traverse that incremental value. If the input signal traverses at the same rate over a number of increments, then a vector is created as a multiple number of increments and the total elapsed time. The process is then reset and continued for the next data word. With a noisy input signal, the threshold value is fired too quickly in rapid succession, resulting in spurious data. As an improvement, a tight read loop is used to increment (for a quickly rising signal) or decrement (for a quickly falling signal) the threshold window based upon the direction of the preceding trigger and then reset and monitor to see if it immediately fires again. The system continues to loop and monitor the firing without storing a new timestamp for the data until it either reads a new bit value stable in relation to the previous bit value, or having looped a given number of times ‘x’ that will flatten out noisy input signals. The number ‘x’ is preferably calibrated to a value such that the response time of the hardware multiplied by ‘x’ times is less than (Timer Hz/(signal bandwidth (SB)*2))/Number of bits.

Other objects, features, and advantages of the present invention will be described in further detail below, with reference to the following drawings:

### BRIEF DESCRIPTION OF DRAWINGS

FIG. 1 is a schematic block diagram illustrating an example of the logic sequence for a system for managing distribution of digital audio content in accordance with the present invention.

FIG. 2 is a schematic block diagram of an apparatus for encoding an audio waveform as time-demarcated digital messages of a digital audio content file.

FIG. 3 is a schematic block diagram of an apparatus for reproducing (playing back) an original audio waveform from the encoded digital audio content file.

FIG. 4 shows a representation of an audio waveform in which wave points thereon are determined for encoding as digital messages of a digital audio content file.

FIG. 5 shows a representation of an audio waveform in which noise wave points thereon are encoded as flat line conditions in the waveform.

FIG. 6 is a logic flowchart illustrating the encoding operation of audio content to a digital audio content file.

FIG. 7 is a logic flowchart illustrating the decoding operation from a digital audio content file on playback.

FIG. 8 is a table of vectors representing segments of an audio waveform with the high frequency vectors highlighted for an example.

FIG. 9 shows a representation of an audio waveform upon full playback including high frequency vectors of the audio data file.

FIG. 10 shows a representation of an audio waveform upon low resolution playback omitting high frequency vectors of the audio data file.

### DETAILED DESCRIPTION OF INVENTION

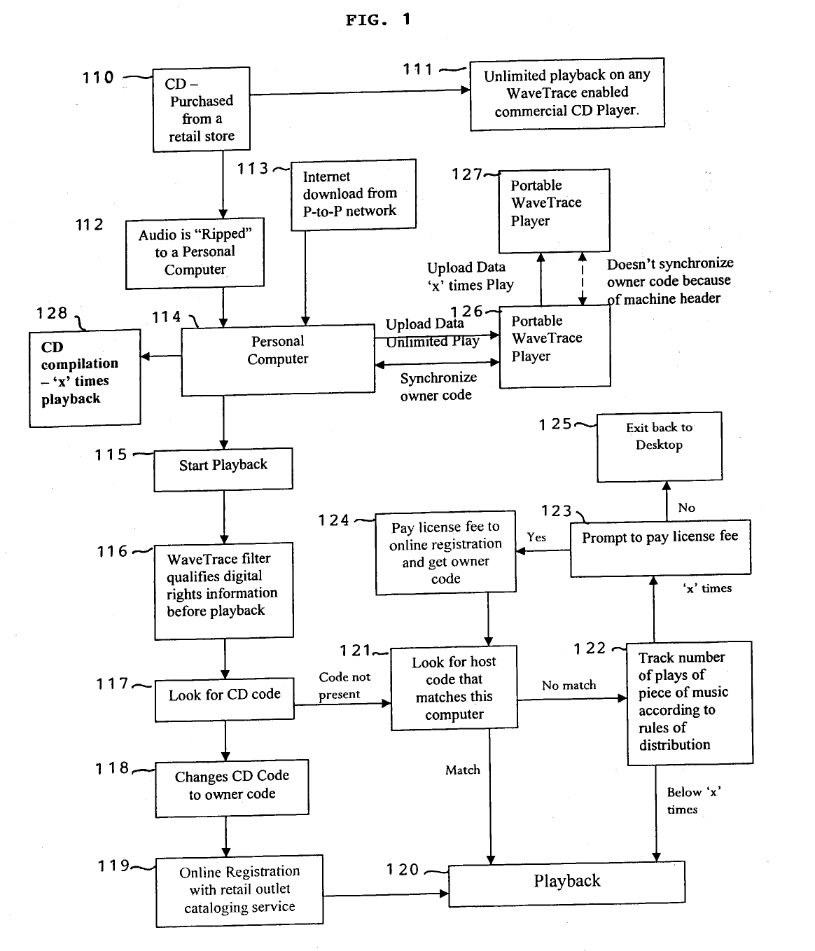

Referring now to the drawings and in particular to FIG. 1 thereof, the system for managing distribution of digital audio content in accordance with the present invention is illustrated schematically. In this system, digital audio content is digitally encoded using a “vector” encoding method, for example, as described in U.S. Pat. No. 6,020,840 and 6,177,898, incorporated herein by reference (explained in greater detail below). The preferred vector-encoding method described in these patents is referred to herein as “WaveTrace” technology. However, it is to be understood that other equivalent vector-encoding methods may also be used. In vector-encoding, the digital audio content is represented as a series of digital messages specifying a multiplier number of amplitude increments of common slope traversed in a segment of the audio waveform, the elapsed time of traverse, and its polarity (up/down). The vector-encoding allows the higher frequency segments of the audio file to be identified with a tracer bit that is set to logical “1” or “high” or other message segment as appropriate. These are identified as segments having an amplitude-per-time traversal rate that exceeds a predetermined level. Other digital messages can be embedded into the data stream, such as the manufacturer's ID (or authorized host-ID), subscriber, copyright, or encryption key information in the data stream. They are tagged as management data, rather than audio data, so that they do not form a part of the playback stream.

The vector-encoded digital audio content may be distributed as a hardcopy on a CD purchased by a legitimate user, as indicated at Block 110, which is free to be played back in full resolution an unlimited number of times on any compatible (vector-decoding-enabled) player having firmware enabling playback of the vector-encoded audio file, indicated at Block 111. A distributor ID code may be used initially in place of a host-ID code, and is recognized by the player as permitting full playback of the audio file from the CD. However, when the vector-encoded audio file is copied (“ripped”) from the CD, at Block 112, or downloaded from the Internet, at Block 113, to a host environment, such as a personal computer (PC) indicated at Block 114, a vector-decoding enabled (WaveTrace) software player installed on the PC will execute a prescribed sequence of distribution management functions in accordance with the present invention. When the receiving host environment attempts playback, at Block 115, the WaveTrace player checks the distribution rights messages embedded in the audio file before playback, at Block 116. If the audio file has been loaded from a legitimately purchased CD, the WaveTrace player checks for the distributor's ID code, at Block 117. If the distributor's ID code is recognized, the WaveTrace player changes it to a host-ID code identifying the user as the authorized host environment, at Block 118. The host-ID code may be generated from the user's machine serial number or the serial numbers of components in the host machine such as the microprocessor, hard drive, or operating system license number. Alternatively, or as a follow up, the user may be prompted to register its host-ID code for the audio file with an Online Registration Site established to manage the distribution rights for audio files within the system, indicated at Block 119. Completion of the registration step allows the now-authorized user to proceed with playback at full resolution and an unlimited number of times, at Block 120. Unlimited playback is enabled when the WaveTrace player checks the audio file for the host-ID code and finds one that matches the code numbers for that user or user's machine.

If the WaveTrace player does not find a distributor's ID code at Block 117, it checks for a matching host-ID code at Block 121. If a host-ID code match is found, the WaveTrace player proceeds to unlimited playback at Block 120. If a host-ID code match is not found, the WaveTrace player enables only limited playback at low resolution, by flat-lining the marked higher-frequency digital messages (as described further below), and for a limited number of times “x”, indicated at Block 122. A count of playback times is updated in the management data of the audio file. If the count is below “x”, low resolution playback is enabled. When the count reaches “x”, playback is no longer enabled and instead the user is prompted to pay a license fee for full playback rights, at Block 123. The user can then go to the Online Registration Site, at Block 124, and arrange for payment of the required license fee and also receive a decryption/encryption key used by the WaveTrace system to rewrite the host-ID code embedded in the audio file to that of the registering user or user's machine. If the user does not complete the license payment and registration procedure, the WaveTrace player exits the management sequence without enabling any level of playback, at Block 125.

The system provides for transferring a licensed WaveTrace file to a handheld player for portable access to the music. Portable players will be licensed WaveTrace-enabled devices that have their own manufacturer's ID code. This code tells the system that it is a portable device that is going to be downloading WaveTrace files from a host environment. If the host-ID code embedded in the audio file matches the authorized host PC at Block 114, the WaveTrace player on the PC will be allowed to upload the audio file to the portable player that is connected to the authorized host PC, as indicated at Block 126. The authorized upload function includes a rewriting of the host-ID code embedded in the audio file to include a header for the manufacturer's ID of the portable player connected to the authorized host PC, thereby enabling the portable player to recognize a match of the host-ID code to its own manufacturer's ID code to allow unlimited playback. Thus, the authorized user can upload the audio file to any portable player machine physically connected to the authorized host PC. However, if a user uploads a copy from one portable player to another portable player, indicated at Block 127, there is no synchronization of the host-ID code, and the receiving player will allow only limited playback at low resolution and a limited number of times “x” because the receiving player's machine ID will not match the header incorporated in the host-ID code embedded in the audio file. In this manner, an authorized user can share an audio file with a friend for limited trials only. The friend can upload the received audio file to the user's own host PC and perform the licensing and registration procedure to enable full use of the audio file.

An authorized user can also create a compilation of WaveTrace audio files on CD from the authorized host PC. The WaveTrace audio files will have the authorized user's host-ID code embedded in them, and can be played on any CD player. If the CD is duplicated and illegally resold, the last user's host-ID code can be identified from the audio files to locate the source of the pirating. If the CD is played on another host PC, and there is no commercial CD code present in the data files or the host-ID code does not match the current host environment, then playback from the CD will behave as unlicensed files and will follow the rules of distribution for limited playback as indicated at Block 128.

When a user proceeds to register an audio file for full licensed use, the system connects via the Online Registration Site to a central database for verification of the host-ID code and its associated rules of distribution. The Online Registration Site completes the authorization procedure in which the user's host-ID code is rewritten into the WaveTrace audio files via the accessing software logged on to register the audio files in order to identify the authorized host environment. The host-ID number and other management data may be embedded randomly within the audio data (described further below) to defeat attempts to extract the data and compromise the system. In order to further secure the management data, an encryption method is used. Standard encryption methods are well known in the industry, and are not described further herein. The Online site can also provide other distribution management functions, such as maintaining subscribers accounts in which subscribers are allowed to maintain and access respective libraries of music files.

Vector-Encoding of Audio Files

As shown in FIG. 2, an example of a vector encoding apparatus, generally designated by the reference numeral 10, is comprised of six components or stages acting on an input analog waveform to convert the waveform into a series of digital messages representing the movement of the waveform in real time. At the input stage, the encoding apparatus 10 preferably includes a low noise input gain stage 14 for amplifying the peak to peak voltage of the input waveform; a detecting means generally designated by the reference numeral 18; a voltage source generally designated by the reference numeral 22; a timer/counter 24, a high frequency clock source 26, a microprocessor 28; and optionally a storage memory 32 for archiving the digital messages describing a particular analog waveform.

The encoding apparatus 10 performs an analog to digital conversion of a waveform essentially by breaking the input waveform into segments representing a certain minimum change in amplitude of the waveform. Upon every detection of a minimum change in amplitude in the waveform, the creation of a digital message is triggered. The minimum change in amplitude for triggering the creation of a digital message is preferably a value in the microvolt range which is selected prior to beginning a waveform encoding operation and remains fixed throughout.

In selecting the minimum change in amplitude, it may be necessary to first determine the noise components of the waveform to be sampled. In this manner a trigger level may be selected which is high enough to avoid the creation of digital messages that merely represent changes in amplitude corresponding to noise present in the original waveform. Once a minimum value is selected, the value is input and fixed by means of the voltage source 22 which is preferably a digitally controlled voltage source or potentiometer. In the preferred embodiment, the voltage source 22 is connected between the detection means 18 and microprocessor 28.

Briefly, when the amplitude of the input waveform changes a value that is substantially equivalent to the threshold voltage established by voltage source 22, a minimum change in amplitude has occurred which is detected by apparatus 10 triggering the formation of a descriptive digital message. Substantially at the same time a measurement of the elapsed time for the minimum change in amplitude is made and the polarity or direction of the minimum change in amplitude is detected. The elapsed time information and polarity are stored as part of the same descriptive digital message.

As the digital message preferably describes three aspects or characteristics of a tracked segment of the waveform, the preferred format of the digital message is a 32 bit data word wherein bit 32 represents the polarity or direction of the minimum change in amplitude, bits 25-31 represent a multiplier of the minimum change in amplitude and bits 1-24 are used to store the measured elapsed time of the minimum change in amplitude. It should be noted that as the minimum change in amplitude is fixed, a non-compressed data word will typically have a multiplier of one.

An analog waveform to be converted or encoded is first connected to the positive input of the gain stage 14 which as is shown may be a conventional operational amplifier 32 having negative feedback through feedback resistor Rf. The amplified or conditioned signal is then fed to an input side of the detecting means 18 which preferably includes a sample and hold circuit 34 and comparator circuit generally designated by reference numeral 36.

In particular, the output of the input gain stage 14 is coupled to the input of the sample and hold circuit 34, the positive node of a first comparator 40 and the negative node of a second comparator 42. As indicated further in FIG. 2, voltage source 22 is electrically connected to each of comparators 40, 42 for use in detecting the occurrence of a minimum change in amplitude.

In operation, one of comparators 40, 42 may generate a signal at each occurrence of a change in amplitude of the waveform which is substantially equivalent to the level supplied by the voltage source 22. In the event comparator 40 is triggered, a positive minimum change in amplitude has occurred; and in the event comparator 42 is triggered, a negative minimum change in amplitude has occurred.

The outputs of comparators 40, 42 are fed into separate interrupts of microprocessor 28 via connections 44, 46 for distinguishing between the positive and negative minimum changes in amplitude. Upon the firing of one of comparators 40 or 42, the corresponding interrupt receives an input allowing the microprocessor 28 to identify the direction of the minimum change in amplitude and further causing the microprocessor 28 to enable the sample and hold circuit 34.

Once enabled, the sample and hold circuit 34 captures the current value of the conditioned waveform which is being fed from the output of the amplifier 14. The held or captured value is substantially simultaneously fed from the output of the sample and hold circuit 34 to the negative node of comparator 40 and the positive node of comparator 42 via connection. This configuration permits the apparatus 10 to dynamically detect each subsequent occurrence of a minimum change in amplitude as measured between the positive and negative nodes of comparators 40, 42. The process is repeated until the waveform conversion is completed.

As previously mentioned, upon each occurrence of a minimum change in amplitude a measurement of the elapsed time for the minimum change in amplitude is performed and the time value is included in bits 1-24 of the data word. In the apparatus 10, the timer/counter 24 in combination with the high speed clock source 26 are used to measure the elapsed time.

As shown, the timer/counter 24 is coupled to the high speed clock source 26 which is preferably a quartz crystal oscillator. The timer 24 is preferably comprised of a package of three-eight bit timers which permit up to a 24 bit countdown. Conceivably, with such an arrangement, the reference clock can be configured to clock the occurrences of minimum changes in amplitude at a rate of 1 Ghz. or greater.

Generally, in deciding on the speed of the reference clock or time base to be used in measuring the time between the start and end of a minimum change in amplitude, the clock speed must be sufficiently high to mark the time of a voltage transition event accurately enough to prevent skewing in the reproduced waveform. Skewing may occur if the speed or frequency of the reference clock is selected such that when a detectable change in amplitude occurs, it occurs between ticks or pulses of the reference clock with too much room on either side of the transition. As a result a detectable change in amplitude is associated with the nearest clock tick which may lead to an inaccurate reconstruction of the original waveform.

For example, in the case of an audio waveform which has a frequency response of 20 Khz, an appropriate reference clock frequency might be 1 Ghz or 50000 times the highest frequency response. In this manner, the occurrence of detectable changes in amplitude may be associated with a more precise point in time so as to minimize skewing.

Although a reference clock is utilized, the apparatus 10 does not have a fixed data rate per second. The data rate and quantity fluctuate depending on the frequency and amplitude content of the particular waveform fed into apparatus 10. Low frequency waveforms have a much longer periodic wave and, consequently, a change in amplitude takes longer to reach each detectable threshold point. This gives an output which intrinsically exhibits a data compression characteristic such that in moments of silence a digital message may only occur once every 24 bit period. The highest concentration of data will occur when the waveform contains a high frequency content of a high amplitude.

Data compression may be enhanced or supplemented by performing a slope integration along a section of a sampled waveform. Data words having a common slope as determined by the minimum change in amplitude, which is fixed, and the elapsed time for the change in amplitude, which is variable, may be combined into a single new data word representing all sequential data words along a common slope. In FIG. 4, a sample waveform is shown having new data words W1-W20. Data word W4, for example, represents a combination or slope integration of the individual data messages which were generated to describe the segment of the waveform between W3 and W4.

The slope integration is accomplished by performing a comparison of the elapsed times of sequential data words. In the instance where sequential data words have an equivalent elapsed time, within a given tolerance, the sequential data words are combined to form a new or final data word. The new or final data word describes a total elapsed time and further describes the total change in amplitude of the waveform during that elapsed time by a multiplier representing the total number of occurrences of a minimum change in amplitude. Thus, for example, if three sequential data words are combined to form a new or final data word, the multiplier representing the minimum change in amplitude would be three.

An additional operation which may be performed on the data words is useful in determining the start of a minimum change in amplitude after a period where no signal has been detected, otherwise known as a flat line condition. The operation essentially derives a data word representing a data point along the waveform which has not been detected but rather calculated and interposed based on the information contained in data words created prior to and immediately after the calculated data point. In FIG. 5, the derived data point is represented as point P1a located between points P1 and P2. If a data message representing point P1a is not inserted as a point the recreated waveform would resemble more closely the waveform represented by the dotted line extended between the points P1 and P2.

The operations of slope integration and flat line tracking will become more apparent upon an understanding of the microprocessor 28 operations during a waveform conversion. Accordingly the remainder of the operation of the apparatus 10 will be described in connection with the operation of the microprocessor 28.

The microprocessor 28 monitors interrupts generated by either of the two comparators 40, 42 and the timer 24. At the start of a conversion and recording process the following occurs: the microprocessor initializes the components, which includes establishing the threshold voltage for the conversion as fixed by voltage source 22, setting the sample and hold circuit to a 0-volt level, loading the timer 24 with a divisor value to achieve a desired reference clock rate and zeroing the software counters for clocking the elapsed time of a minimum change in amplitude.

Following initialization, the microprocessor is ready to generate a digital message. To that end the timer 24 begins to run and upon each timer countdown, the timer generates an interrupt via line 50 to the microprocessor which upon request increments a timer variable. The timer variable preferably located in the microprocessor 28 tracks the elapsed time for every occurrence of a detected minimum change in amplitude. If the timer variable reaches a maximum value without there being a minimum change in amplitude, the microprocessor 28 generates a data word having a multiplier value of zero indicating that a minimum change in amplitude has not occurred within a maximum period of time as limited by the 24 bit size of the data field.

The value of the timer variable per occurrence of a detected minimum change in amplitude is temporarily stored in a work buffer by the microprocessor. The elapsed time value is retrieved and written to a data word together with the polarity and multiplier field information. Upon the writing of the data word a flag is set indicating that the data word is ready for further processing by the microprocessor 28.

The microprocessor 28 is preferably equipped with at least two buffers (not shown) which are used to temporarily store the created data words. Initially data words are stored in a first buffer (Buffer 1) and following a slope integration or flat line tracking operation are stored in a secondary buffer (Buffer 2). The data words stored in the secondary buffer are the final data words which contain the information for reproducing the original waveform.

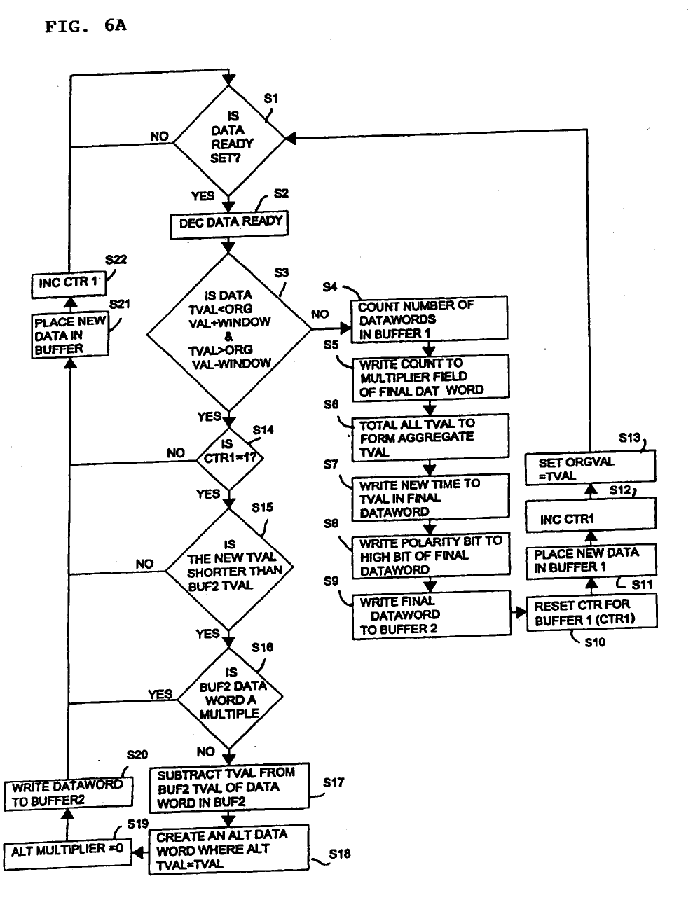

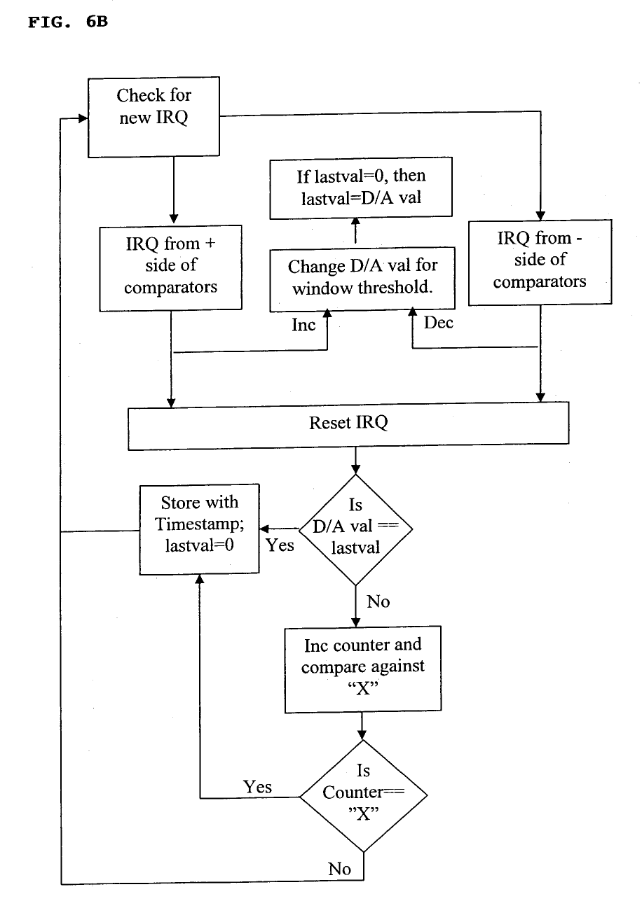

The typical operation of a main routine of the microprocessor is best understood in connection with FIG. 6A which includes a description of the operations of slope integration and flat line tracking. In first steps S1 and S2, each newly created data word is detected as indicated by a data ready signal and processed by the microprocessor 28. In step S3, the elapsed time, Tval, of the newly created data word is compared to the elapsed time, Orgval, of an immediately prior data word held in the first buffer, if any. If the elapsed times Tval and Orgval are not equivalent within a plus and minus tolerance, a final data word having a new Tval and multiplier is generated and stored in the secondary buffer.

As represented in steps S4 to S9, in generating the final data word the data words then present in the first buffer are totaled. This total is written to the multiplier field of the final data word. The Tval of the final data word is derived by aggregating the Tval for each data word then present in the first buffer. The aggregate Tval is then written to the Tval of the final data word. The final data word including the correct polarity is written to the secondary buffer.

Following this operation, the first buffer is reset and the newly created data word is placed as the first entry in the first buffer, the buffer address counter is incremented and Tval is set equal to Orgval. The microprocessor 28 is now ready to receive and process the next newly created data word.

As indicated in steps S3 and S14, if Tval of a newly created data word is equivalent to Orgval within a certain positive and negative window, the newly created data word is checked to determine its location in the first buffer. If the newly created data word is in any location in the first buffer other than the second position, the newly created data word is written to the first buffer and the buffer address counter is incremented by 1. The microprocessor 28 is again ready to process the next newly created data word.

Steps S15 to S20 are performed if the newly created data word is in the second position in the buffer. In accordance with steps S15-S20, the Tval for the newly created data word is compared against the Tval for the last stored data word in buffer 2. The Tval for the buffer 2 data word is determined by dividing the total elapsed time field by the multiplier field. If Tval of the newly created data word is smaller than Tval for the buffer 2 data word and not a multiple thereof then a next final data word is written to the secondary buffer having a polarity of the buffer 2 data word, a multiplier of 1, and a Tval equal to that of the Tval for the newly created data word. The routine then subtracts Tval of the newly created data word from Tval of the buffer 2 data and changes the Tval of the buffer. This modified final data word of buffer 2 is written to the secondary buffer. The newly created data word is placed in the first buffer and the buffer address counter is incremented by 1. The microprocessor 28 is ready for the next newly created data word.

At step S15, if the Tval of the newly created data word is larger than Tval of the buffer 2 data word, the microprocessor writes the newly created data word to the first buffer, buffer 1, and increments the buffer address counter by 1. The microprocessor 28 is ready for the next newly created data word.

The microprocessor 28 will continue its routine until each data word is processed. At the end of the final data processing words stored in the secondary buffer may be transferred to the storage memory 32. Once in the storage memory 32, the data words may be retrieved by a decoding apparatus in order to reproduce the original waveform.

The present invention also encompasses an improvement to the vector encoding process described above. It has been found that in the previously described process, a problem can arise when the system attempts to digitize a noisy input signal. Using the circuit as described, there is a tendency for noise to cause the window threshold detector to trigger and cause the system to take false reads with respect to the actual waveform. This will cause the circuit to generate an abnormal amount of significant data as the noise crosses the threshold and then drops back down. When this is combined with a moving waveform, the possibility exists that the digital representation can become offset from the original by several bits of error without some means of correlating the acquired digital information to the incoming waveform. Another problem is the transient response of such a system, where an incoming transient can create an enormous amount of instantaneous data that needs to be responded to. In order to maximize the system response and not distort the incoming signal, the system is modified in order to acquire and represent transient data as expeditiously and accurately as possible.

To solve the above-mentioned problem, a tight read loop is incorporated into the process for acquiring the vector data whereupon, when there is a transition of the incoming signal across the threshold, and as it generates a signal to the circuit to acquire the data, the system software first reads the real-time clock for the elapsed time, holds that value in memory, then proceeds to increment or decrement the window to the new value based upon the direction of the preceding trigger and then reset and monitor the window threshold to see if it immediately fires again. The system then loops with this procedure and monitors this firing without taking a new time value until the system either stabilizes at a new bit value, having counted up and down, following the input signal, or having continued to read subsequent triggers for ‘x’ number of times, ‘x’ being a variable which will determine the degree of resolution for a noisy signal. After one of these conditions are satisfied, the system attaches the time value to the data, including the number of bits that the signal has traversed during this instant and forms the data word. It is important to note that in the case of a very noisy signal, once the loop times out, the system will most likely fire again, indicating that another threshold has been crossed. To prevent an overload of data, it will be necessary to calibrate ‘x’ to a value that will yield good results, for example, a factor of such that the response time of the hardware multiplied by ‘x’ times is less than (Timer Hz/(signal bandwidth (SB)*2))/Number of bits.

FIG. 6B illustrates an example of a routine for implementing the tight read loop. This routine is performed in Step S1 in FIG. 6B before the start of each loop of the coding routine. When the tight read loop routine has satisfied the conditions for triggering the attachment of the time value to the previous data, the routine passes the resultant data and sets DataReady to a “1” in “Is DataReady Set” in Step S1. The routine operates by first checking the trigger IRQ for a new transition of the incoming signal across the threshold window. If the IRQ is from the minus side of the comparators the D/A value for the window threshold is decremented by a given amount, or if the IRQ is from the plus side of the comparators the D/A value for the window threshold is incremented by the given amount, then the IRQ is reset. If the window threshold is immediately fired again, the system continues to loop by decrementing/incrementing the D/A value, each time incrementing the counter for the number of loops before checking for a new IRQ without storing a timestamp value. If the data read reaches a new bit value that is stable, i.e., equal to the last value (D/A val=lastval), then a timestamp is stored. The tight read loop is reset by setting lastval=0, the counter is reset, exited, and the DataReady flag in Step S1 is set to “1”. Similarly, if the loop counter has counted ‘x’ number of times, then a timestamp is stored, and the tight read loop is reset. This improvement of the vector encoding routine provides for auto-correlation and improved transient response of the system. The rising/falling edge of any input signal whether a pulse wave or input transient spike can immediately be acquired with this method, with minimum distortion, and full phase accuracy.

Decoding/Playback of Audio Files

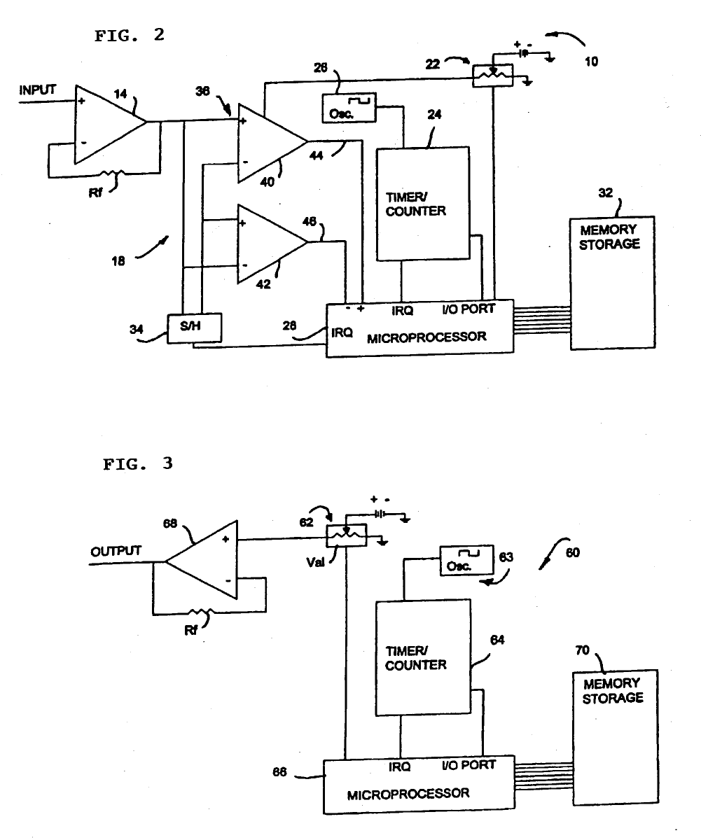

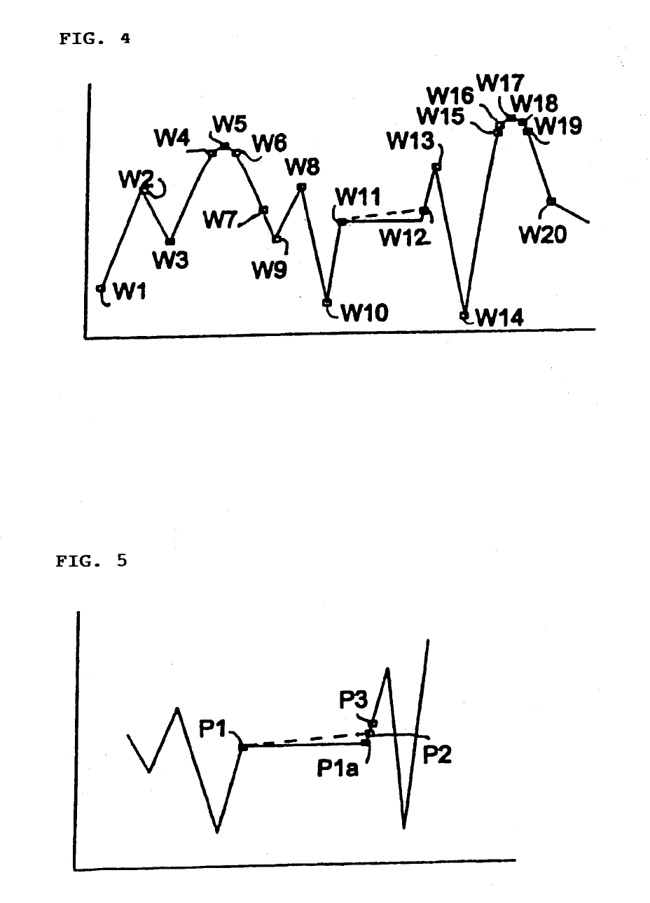

Referring now to the schematic block diagram of FIG. 3, an example of a decoding apparatus 60 is shown for reconstructing or reproducing an original analog waveform from the information contained in the plurality of digital messages. The digital messages are preferably in the format already described herein, namely, a 32 bit data word wherein bit 32 represents the polarity or direction of the minimum change in amplitude, bits 25-31 represent a multiplier of the minimum change in amplitude and bits 1-24 are used to store the measured elapsed time of the minimum change in amplitude.

The decoding apparatus 60 is generally comprised of four components or stages acting to retrieve and convert a plurality of sequentially stored data words into a precise reconstruction of the original analog waveform. The decoding apparatus 60 is comprised of a voltage source generally designated by the reference numeral 62, preferably a digital potentiometer, a high frequency clock source 63 and timer/counter package 64 to give a programmable time base or reference clock of flexible duration, a microprocessor 66, and an output gain stage 68. The digital messages are retrieved from a storage memory 70 or some type of external memory device which has not been shown in the figures.

In general, the decoding or D/A conversion is conducted in an inverse manner to the encoding or A/D conversion. The timer 64 is loaded with a clock value for the conversion. Initially the clock value should be the same as that used in the A/D conversion. Like the timer of the encoding apparatus 10, the timer 64 may comprise three eight bit timers for establishing the time base or reference clock of apparatus 60.

In reconstructing the original waveform from the recorded digital messages or data words, the microprocessor 66 which, as shown in FIG. 3, is coupled to the digital potentiometer 62 and timer 64 is first initialized. Initializing the microprocessor 66 includes loading the timer 64 with the appropriate divisor for the desired reference clock and zeroing the software counters.

Following initialization the microprocessor 66 executes a fetch cycle and retrieves a first data word from memory 70. The microprocessor 66 multiplies the threshold voltage by the value stored in the multiplier field of the retrieved data word to derive a full voltage range. The full voltage range is used to calculate the increments of voltage change relative to the total elapsed time contained in the time field of the retrieved data word. The incremental voltage change is then applied to the digital voltage source in a manner proportional to the total elapsed time as indicated by the retrieved data word. This process is repeated for every retrieved data word.

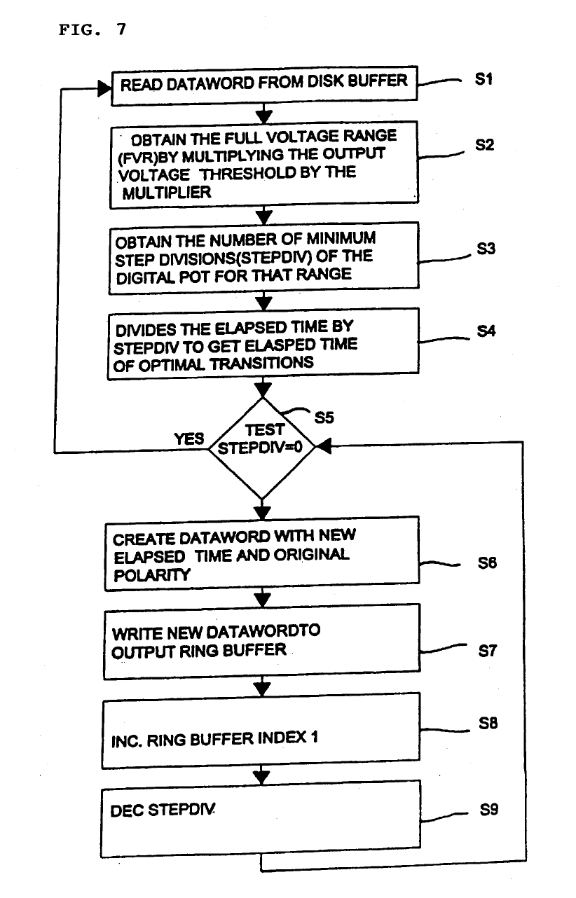

To improve the quality of the output waveform, each data word retrieved from memory 70 is further subdivided into yet smaller data words by taking advantage of the generally higher grain or output resolution of the digital potentiometer 62. As indicated in steps S1 to S9 of the flowchart of FIG. 7, the full voltage range of each retrieved data word is divided by the maximum resolution of one increment of the digital potentiometer 62. This gives the number of step divisions available for a smooth output transition over time in accordance with the generally higher resolution of the digital potentiometer 62.

Next, in step S4, the elapsed time represented in bits 1-24 of the retrieved data word is divided by the total number of step divisions to create a string of new data words that represent one step of the digital potentiometer 62 that is to occur at averaged divisions of time points across the total elapsed time of the retrieved data word.

The elapsed time of each of the newly created string of data words is loaded into a timer variable. The timer 64 which is connected to an interrupt or IRQ pin on the microprocessor 66 generates a signal at each count down of the timer 64. At each timer 64 interrupt, the timer variable is decremented until the value reaches zero. When the timer variable reaches zero the routine increments or decrements the level of the digital potentiometer by one unit of resolution. It then reloads the timer variable with the next new data word and follows the same procedure until all the new data words have been transmitted and output via gain stage 68 which is coupled to the output of the digital potentiometer 62. This process is repeated for each of the remaining data words stored in memory 70 until the full original waveform has been recreated.

By recreating the analog waveform in this manner, it is possible to eliminate the need for the output smoothing filters otherwise necessary to reconstruct an analog waveform using conventional technologies.

In order to optimize the amount of data, it is possible to insert realtime messages which alter the response of the Digital to Analog converter to allow for additional compression. For example, a realtime message may be used to change the value of the trigger or threshold voltage to a value different than the startup value or to inversely change it back. In this manner the recreation of a particular segment of the waveform may be adjusted to coincide with the number of data words which have been created to describe that particular segment of the original waveform.

Managing Distribution of Audio Data Files

The controlled distribution of audio files in the present system is managed primarily through the Online Registration Site (see Block 124 in FIG. 1). The main database of subscribers and their information is kept on a server that can be accessed via the Internet. The database keeps information about each subscriber, their subscription account which payments are made from, the listing of their purchases, a password, which allows the subscriber to causatively access their account, and a private key combination, which is used to synchronize the database account to the subscriber's host environment.

The subscriber's private key provides the security between the host environment and the database. This key can be continually changed with every access to the main server, which insures against hacking of a particular account. If a user attempts to access their account and has a problem, the user can login with their password and re-synchronize the host environment to the server database. This allows for a double-challenge style of security procedure where an illegal access attempt can be overridden via a password access. In this manner, it will be possible to cross check a subscriber's ID, which is automatically transmitted upon attempted access with the server, with the host environment number, and upon failing, the account can be again cross checked against the user's name and password.

The private key is generated by the server as a 32 bit random number that is saved in the subscriber's account, as well as transmitted to the host whereupon the host saves the key as a function of an encryption method using a combination of numbers that can be retrieved from one or many of various components that exist in the user's computer system. In its preferred embodiment, this number series can be retrieved from the IC chip by which the vector-encoding/decoding functions are performed as a subsystem of the PC's audio system. To increase accountability, the subscriber ID number is embedded into every audio file that is licensed and encrypted as part of the general encryption method used to secure the file.

The private key data may be interspersed randomly among the audio file data so that it cannot be easily extracted and compromised. In conventional Digital Rights Management (DRM) methodologies, the TCP/IP packets are encrypted. These packets are a fixed size and transmitted in a fixed order, so it is somewhat easier to determine where the container starts, where the data starts and ends, and what should be operated upon to break the encryption. If the file is saved to disk with the encryption, generally, it still maintains the set packet sizes of encrypted data. In a more secure dispersal method, a TCP/IP packet can include a mix of non-encrypted and encrypted data, where the encrypted messages are flagged by a special bit in the data field. During playback, the audio data file is parsed linearly through each digital data message in order to determine how the file should be played back. Each digital message can contain any data, encrypted or not. Private keys are only a part of the information that can be included in a message packet. Subscriber information or ID, Host ID, copyright info, can all be included in message packets. Typically, the system can recognize a message byte that has the “high” bit set denoting encrypted data, thereby telling the system that the message byte contains management data that should be taken out of the audio playback data.

The vector encoding of audio files makes it easy to determine which vectors represent high frequencies and to filter out the high frequency sound quality until the proper licensing condition is met. Thus, the same audio file can be used to demo a song at a lower quality/resolution and then upon licensing, restore the full frequency response of the audio data to full quality. After the audio file has been licensed, the Subscriber ID and Host ID are embedded in the data file in an encrypted packet. When the host system goes to play the music file, it first checks for these ID numbers and cross correlates them against the Subscriber/Host combination present on the computer system. If the numbers all match, then the file plays. If the numbers do not match, the music file goes into demo mode and plays the limited bandwidth version.

Because the vectors are recorded as voltage over time, the time component is easily recognized such that a low frequency wave vector will take longer to move from point to point than a high frequency wave vector. For example, a low frequency (low sine) wave might take 158 nanoseconds to traverse a waveform amplitude increment, whereas a high frequency (high sine) vector might take 16 nanoseconds to traverse the same amplitude increment. Consequently, a cutoff level for amplitude-per-time can be used to identify high frequency vectors from low frequency vectors. Identified high frequency vectors can then be put into a message packet where the first byte has the “high” frequency flag enabled and the following succession of bytes are encrypted using a standard encryption methodology. If the playback system recognizes that the file was “licensed”, then this high frequency data would be decrypted and included as part of the playback stream, otherwise, this data would be skipped over and straight line interpolation between the remaining low frequency vectors would be substituted in its place.

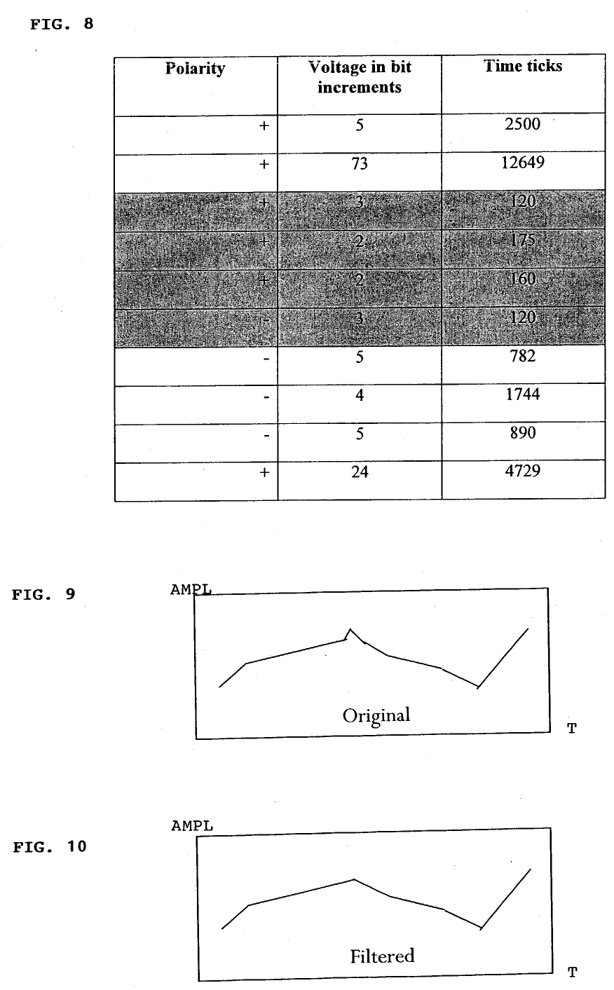

An example of the encoding of a section of audio waveform is provided in the chart shown in FIG. 8. In the chart, the highlighted vectors represent waveform segments of amplitude increments with relatively short elapsed times, and can be designated as “high frequency” vectors. A cutoff level of, say, 150 time ticks per bit increment in waveform amplitude change might be chosen to designate the high frequency vectors. In full playback of high and low frequency vectors, the audio waveform would be reconstituted as shown in FIG. 9. In low resolution playback with the high frequency vectors filtered out and substituted with straight line segments interpolated to the remaining vectors, the audio waveform would appear as shown in FIG. 10.

For playback of a downloaded audio file on a vector-decoding-enabled (WaveTrace) player, the player will only be able to play the low frequency data for a “preview” of the audio work and can only do so for a count of “x” times before it is locked out. To obtain full usage of the audio data file with its full sound quality, the recipient must log on the Online Registration Site and pay a license fee in order to receive a private key matched to the recipient's Subscriber ID and Host ID in order to enable unlocking and use of the full audio data file.

In the case of a commercial CD, the Subscriber/Host ID is initially set to a CD product code and distributor code. Additionally, the decoder would search elsewhere for a standard product ID that identifies the CD as a commercial product. The three pieces of data must correlate for the CD to play with full response. This information can also be present when the system mounts the CD and would allow the system to crosscheck this with data that would be included in the data stream. The management data for the audio file are logically read as header information for the audio file. A typical header would include the following distribution management data:

1. Distributor ID—The assigned ID for each Record Company, Store, Online site, etc.

2. Artist ID—Artist registration number which is assigned for release of works in the distribution system.

3. Product ID—Individual Product ID

4. Subscriber ID—The number assigned to each system subscriber.

5. Host ID—The number that is created by a combination of hardware component numbers and/or the serial number of the IC codec (WaveTrace) chip. This is used to identify the user's computer environment and lets the system know that the particular host is authorized to playback the audio file fully.

6. Encryption ID—This ID designate a specific encryption method used. By including this ID message in the data stream, it will be possible to change encryption methods mid-stream, thus increasing the security of the system.

7. Index to Rules of Distribution—This allows the licensing methodology of each song to be handled in a different manner or to have different license fees.

The Rules of Distribution for each licensed work is maintained as a database table residing on the server that describes how the music file is to be treated for licensing. A typical Rules table would include, but is not limited to, the following data:

1. Rule Number—Index a particular rule for a particular file. May be reused.

2. Distributor ID—The assigned ID for each Record Company, Store, Online site, etc.

3. Publisher ID—The assigned ID for the publisher and owner of the copyright.

4. Number of Auditions—The predetermined number of times that the music file can be played on a particular host system before it becomes unplayable.

5. Charge—The license fee.

6. Accompanying Text—Any message that should be printed along with the display of the rule.

7. Action—Link to an action that should take place. This provides for either a complementary or an alternate functionality that the rule would then branch to, such as a redirect to a transaction processing service, or a questionnaire or survey, etc.

8. Encryption Keys—Each distribution file can have its own private keys for decryption of that particular piece of music. This allows the encryption to be lightweight for efficient use of microprocessor resources.

Portable network-capable players that utilize USB, FireWire or Ethernet will have a registered Hardware Device ID that is part of the WaveTrace license that allows a computer to upload music files for remote play. The player would link up to the PC and exchange user data, which is a new combination of the Subscriber ID, Host ID and the Hardware Device's ID. This will allow the device to download files for remote play. When reconnected to a PC, if the Subscriber ID and Host ID match, the file can be uploaded back to the PC. If they do not match, upload will be disabled. Portable to portable is also monitored via the Hardware Device ID.

If a compilation CD is burned from licensed music where the Subscriber ID and Host ID match the environment, the CD will be able to be played on any CD player. As soon as it is removed from the CD into a foreign computer environment where the Subscriber ID and Host ID do not match, it then follows the rules of distribution for online medium and has limited play.

It is understood that many other modifications and variations may be devised given the above description of the principles of the invention. It is intended that all such modifications and variations be considered as within the spirit and scope of this invention, as defined in the following claims.

I claim:

1. A method for managing distribution of audio content comprising:
(a) digitally encoding the audio content into an audio data file containing a series of time-demarcated vectors representing segments of an audio waveform;
(b) determining the vectors representing audio waveform segments of high frequencies exceeding a predetermined high frequency level, and marking the corresponding vectors with a tracer so that they can be traced upon playback;
(c) embedding a host-ID code in the audio data file designating an authorized host environment for full unlimited playback of the audio content from the audio data file;
(d) distributing the audio data file to a host environment having a unique host-ID code;
(e) upon determining a match of the host-ID code embedded in the audio data file with the host-ID code for the playback host environment, then enabling full unlimited playback of audio content from the audio data file by digitally decoding the audio waveform from the audio data file including the high frequency vectors; and
(f) upon determining no match of the host-ID code embedded in the audio data file with the host-ID code for the playback host environment, then enabling only low resolution, limited playback of audio content from the audio data file by digitally decoding the low frequency vectors of the audio data file and omitting the high frequency vectors.

2. A method for managing distribution of audio content according to claim 1, wherein the vector encoding is performed by determining for each vector a polarity direction, amplitude increment traversed, and time of traversal.

3. A method for managing distribution of audio content according to claim 2, wherein the vector encoding is performed by measuring time of traversal across a specified minimum amplitude increment.

4. A method for managing distribution of audio content according to claim 3, wherein the vector encoding is performed by specifying a vector comprised of a number of successive amplitude increments of common slope (same rate of time of traversal) and their combined time of traversal as a data compression method.

5. A method for managing distribution of audio content according to claim 1, wherein the high frequency vectors are marked by setting a “high” flag bit of a corresponding digital message packet.

6. A method for managing distribution of audio content according to claim 1, wherein the high frequency vectors are omitted by substituting a straight line interpolation between low frequency vectors.

7. A method for managing distribution of audio content according to claim 1, wherein the host-ID code is generated using an assigned user ID number and/or a serial number of a component of the user's computer as the host environment.

8. A method for managing distribution of audio content according to claim 1, wherein the audio data file is distributed to another host environment via a peer-to-peer network on the Internet.

9. A method for managing distribution of audio content according to claim 1, wherein the low resolution, limited playback is limited to playback for only a specified number of times of trial sampling of the audio content.

10. A method for managing distribution of audio content according to claim 1, wherein the host-ID code for a current host environment is embedded in the audio data file upon performing a registration procedure with an online registration site.

11. A method for managing distribution of audio content according to claim 10, wherein the registration procedure with an online registration site includes payment of a license fee for full unlimited usage of the audio data file.

12. A method for managing distribution of audio content according to claim 1, wherein the audio content may be purchased on a CD having a distributor's ID code embedded therein as the host-ID code, and the audio content on the CD is enabled for full unlimited playback on a CD player capable of recognizing the distributor's ID code.

13. A method for managing distribution of audio content according to claim 1, wherein management distribution information is also embedded in the audio data file and marked so that it can be recognized and omitted from playback.

14. A method for managing distribution of audio content according to claim 13, wherein the management distribution information includes rules of distribution such as defining a specified number of trial samplings of the audio content before requiring licensing.

15. A system for managing distribution of audio content comprising:
(a) at least one user computer being a host environment for playback of audio content from an audio data file, and being identified by a unique host-ID code;
(b) at least one audio data file containing audio content vector-encoded as a series of time-demarcated vectors representing segments of an audio waveform, in which those vectors representing audio waveform segments of high frequencies exceeding a predetermined high frequency level are marked with a tracer so that they can be traced upon playback, and said audio data file also containing a host-ID code embedded therein;
(c) at least one vector-decoding-enabled player associated with the host environment of the user computer for playing back the audio content from the audio data file,
wherein upon said player determining a match of the host-ID code embedded in the audio data file with the host-ID code for the playback host environment, said player enables full unlimited playback of audio content from the audio data file by digitally decoding the audio data file including the high frequency vectors; and
wherein upon said player determining no match of the host-ID code embedded in the audio data file with the host-ID code for the playback host environment, said player enables only low resolution, limited playback of audio content from the audio data file by digitally decoding the low frequency vectors of the audio data file and omitting the high frequency vectors.

16. A system for managing distribution of audio content according to claim 15, further comprising a plurality of users computers connected on a network having respective unique host-ID codes, wherein users through their computers can share copies of vector-encoded audio data files among each other for low resolution, limited playback, and an online registration site connected to the network for allowing a user-recipient of a copy of an audio data file to perform an online registration procedure for embedding the host-ID code for the user-recipient in the received copy of the audio data file to enable full unlimited playback.

17. A system for managing distribution of audio content comprising:
(a) at least one user computer being a host environment for playback of audio content from an audio data file, and being identified by a host-ID code unique to the user computer, wherein the audio data file contains a host-ID code embedded therein and audio content that is vector-encoded as a series of time-demarcated vectors representing segments of an audio waveform, in which those audio waveform vectors representing segments of high frequencies exceeding a predetermined high frequency level are marked with a tracer so that they can be traced and omitted upon playback in a low resolution, limited playback mode if the embedded host-ID code does not match the host-ID code of the user computer as the host environment; and
(b) an online registration site connected to the network for performing an online registration procedure with the at least one user computer wherein the host-ID code for the user computer as the host environment is embedded in the audio data file to enable full unlimited playback on the user computer.

18. An apparatus for playback of audio content from an audio data file containing audio content vector-encoded as a series of time-demarcated vectors representing segments of an audio waveform, in which those vectors representing audio waveform segments of high frequencies exceeding a predetermined high frequency level are marked with a tracer so that they can be traced upon playback, and the audio data file also contains a host-ID code embedded therein, said playback apparatus comprising:
(a) a computer operable as a host environment for playback of audio content from the audio data file which is identified by a unique host-ID code; and
(b) a vector-decoding-enabled player associated with the host environment of the user computer for playing back the audio content from the audio data file,
wherein upon said player determining a match of the host-ID code embedded in the audio data file with the host-ID code for the playback host environment, said player enables full unlimited playback of audio content from the audio data file by digitally decoding the audio data file including the high frequency vectors; and
wherein upon said player determining no match of the host-ID code embedded in the audio data file with the host-ID code for the playback host environment, said player enables only low resolution, limited playback of audio content from the audio data file by digitally decoding the low frequency vectors of the audio data file and omitting the high frequency vectors.

19. A method of playing back audio content from an audio data file comprising:
(a) accessing an audio data file containing audio content vector-encoded as a series of time-demarcated vectors representing segments of an audio waveform, in which those vectors representing audio waveform segments of high frequencies exceeding a predetermined high frequency level are marked with a tracer so that they can be traced upon playback, and also containing a host-ID code embedded therein;
(b) associating the audio data file with a host environment having a unique host-ID code which is enabling playback of the audio data file;
(c) upon determining a match of the host-ID code embedded in the audio data file with the host-ID code for the playback host environment, enabling full unlimited playback of audio content from the audio data file by digitally decoding the audio data file including the high frequency vectors; and
(d) upon determining no match of the host-ID code embedded in the audio data file with the host-ID code for the playback host environment, enabling only low resolution, limited playback of audio content from the audio data file by digitally decoding the low frequency vectors of the audio data file and omitting the high frequency vectors.

20. An improvement in a method of encoding an analog waveform as a plurality of data vectors, comprising the steps of:
(a) selecting and fixing a threshold amplitude window for use in triggering the creation of each vector;
(b) detecting in the analog waveform the occurrence of an amplitude change which is substantially equivalent to the threshold amplitude window;
(c) detecting an increasing or decreasing polarity of the amplitude change;
(d) measuring an elapsed time for occurrence of the amplitude change that is equivalent to the threshold amplitude window; and
(e) generating a data vector defined in terms of the amplitude change, its polarity, and the elapsed time for occurrence of the amplitude change,
wherein the improvement comprises providing a tight read loop which increments (for a quickly rising waveform) or decrements (for a quickly falling waveform) the threshold amplitude window based upon the increasing or decreasing polarity of the preceding amplitude change, respectively, and continuing to detect the analog waveform for a new amplitude change without storing the elapsed time for the data for the previous amplitude change until the tight read loop either reads a new amplitude change that is equivalent to the previous threshold amplitude window, or it has looped a given number of times ‘x’ selected for flattening out a noisy input waveform.

21. An improvement in a method of encoding an analog waveform according to claim 21, wherein the number ‘x’ is calibrated to a value such that the response time multiplied by ‘x’ times is less than (Timer Hz/(signal bandwidth (SB)*2))/Number of bits.
